(19) United States
(12) Patent Application Publication
(10) Pub. No.: US 2005/0003750 A1
(43) Pub. Date: Jan. 6, 2005

(54) Dispensing coin hopper apparatus

(76) Inventors: Yusuke Inuki, Himeji-shi (JP); Kousaku Kayahara, Himeji-shi (JP); Yasuo Irie, Iwatsuki-shi (JP)

Correspondence Address: Joseph W. Price;SNELL & WILMER L.L.P., Suite 1200, 1920 Main Street, Irvine, CA, 92614-7230, US

(21) Appl. No.: 10/842,365

(22) Filed: May 10, 2004

(30) Foreign Application Priority Data
May 9, 2003 (JP) JP2003-130963

(51) Int. Cl. G07D 1/00

(52) U.S. Cl. 453/57

(57) ABSTRACT

[Problem to be solved] The first purpose of this present invention is that when the coins are moved by the pushing piece of the rotating disk, the friction between the coin and the guiding surface reduces. The second purpose of this invention is that when the coins are made up from a soft material, the coins do not get damaged and/or worn.

[Means of solved] A coin hopper comprises of; a bowl which stores coins, a rotating disk which is located at the bottom section of said bowl and has a pushing piece for pushing said coins, and a guiding surface which guides said coins which move together with said rotating disk characterized in that, said pushing piece has a pushing moving section and a pushing out section, said pushing moving section which is located on an extending straight line which extends towards the circumferential direction, said pushing out section which is located at the outer side of said pushing moving section and is located on the straight line which crosses in an obtuse angle to said line.

### DETAILED DESCRIPTION OF THE INVENTION

1. Technical field to Which the Invention Pertains

This invention is related to a coin hopper with an improved rotating disk.

Especially, this invention is related to a coin hopper which does not damage coins which are made from softer materials.

In this specification, “coin” includes generally a coin, a token for amusement and a medium which has the same function.

2. The Prior Arts

In a prior art, the pushing moving piece of the rotating disk is made up from an involute curve which is located at the center corresponding to the rotating axis, because coins are dispensed smoothly (for example patent documents No. 1 and 2).

Therefore coins are pushed always to the periphery direction in a large force. As a result, the periphery surfaces of the coins are pushed to the guiding surface in a large force and move together with the rotating disk.

The patent documents No. 1

Japanese Laid open Patent 7-114658 (FIG. 1).

The patent documents No. 2

Japanese Patent No. 3273069 (FIG. 4 and 7).

### Problems to be Solved by the Invention

When Japanese coins are used, cupronickel coins; for example 500 Yen, 100 Yen and 50 Yen are relatively strong, and the friction between the guiding surface and coin is relatively small.

Bronze coins; for example 10 Yen, and aluminum coins; for example 1 Yen are relatively soft, and the friction between the guiding surface and coin is relatively large.

When the coins are made of a soft material; for example bronze or aluminum, the consumption energy of an electrical motor is larger.

Also, when the coin's material is softer; for example aluminum, the rim of the coin can get damaged.

Accordingly, the thickness of the coin increases.

As a result, the deformed coins are distinguished in misclassification.

Also, the coin's rim is worn away.

Therefore the weight of the coin is reduced.

As a result, the coin is distinguished in misclassification.

The first purpose of this present invention is that when the coins are moved by the pushing piece of the rotating disk, the friction between the coin and the guiding surface reduces.

The second purpose of this invention is that when the coins are made up from a soft material, the deformation and/or the wear are prevented.

### Means for Solving the Problem

For solution of this problem, this present invention is as structured as follows.

A coin hopper comprises of; a bowl which stores coins, a rotating disk which is located at the bottom section of said bowl and has a pushing piece for pushing said coins, and a guiding surface which guides said coins which move together with said rotating disk characterised in that, said pushing piece has a pushing moving section and a pushing out section, said pushing moving section which is located on an extending straight line which extends towards the circumferential direction, said pushing out section which is located at the outer side of said pushing moving section and is located on a straight line which crosses in an obtuse angle to said line.

In this structure, the coins are pushed by the pushing moving section and move together with the rotating disk.

The pushing moving section is located on the straight line which extends towards the periphery direction from the center of the rotating disk.

Therefore the coin is pushed to the straight line in a right angle.

In other words, the coin is pushed to the guiding surface by a small force by the pushing moving section and centrifugal force.

Accordingly, the friction resistance between the coin and the guiding surface is small.

As a result, the consumption energy of the electrical motor reduces.

Also, when the coins are made of soft metal, they do not get damaged and wear at a short time.

In this present invention which is claimed in claim 2, the rotating disk includes an opening which passes through said coins and said pushing moving section and pushing out section is located below and adjacent said opening.

In this structure, the coins fall into the openings and pile up, then only the lowest coin is pushed by the pushing moving section and the pushing out section, and are dispensed.

Therefore the rotating disk can be located level.

As a result, the storing amount of coins is increased in smaller coin hoppers.

In this present invention which is claimed in claim 3, a coin hopper comprises of;

a bowl which stores coins,

a rotating disk which is located at the bottom section of said bowl and has a pushing piece for pushing said coins,

a guiding hole which includes a guiding surface which guides said coins and where said rotating disk is located into said guiding hole,

a base which is located at the bottom of guiding hole and can slide said coins which pass through said opening,

a first pin and a second pin which protrude from said base, characterized in that,

said pushing piece includes a pushing moving section and a pushing out section,

said pushing moving section which is located on an extending straight line which extends towards the circumferential direction,

said pushing out section which is located at the outer side of said pushing moving section and is located on a line which crosses in an obtuse angle to said line,

said pushing moving section is located between said first pin and said second pin,

said pushing out section is located at the side of the circumferential direction rather than said second pin.

In this structure, the fallen coins into the openings are pushed by the pushing moving sections and slide on the base, and are guided by the guiding surface and move together with the rotating disk.

The moving coins either do not have contact with the first pin or have contact with the first pin, and are pushed out to the periphery direction of the rotating disk.

Next, the coins have contact with the second pin, and are pushed towards periphery direction of the rotating disk.

Finally, the coins are pushed out by the pushing out section.

When the coins move together with the rotating disk, the pushing moving section is located on the straight line which extends towards the periphery direction of the rotating disk from the center of rotating disk.

Therefore the coin is pushed in an right angle to the straight line by the pushing moving section. In other words, the coin is pushed to the guiding surface by a small force by the pushing moving section and centrifugal force.

The centrifugal force is drastically smaller, because the coins are not heavy and the rotating speed is slower.

Also, the pushing force of the pushing moving section adds to the tangent direction to a circle which is the center of the rotating disk and is on a point of contact between the guided coin and the pushing moving section.

Therefore the component of the force which pushes to the guiding surface is small.

Accordingly, the friction resistance between the coin and the guiding surface is small.

As a result, the consumption energy of the electrical motor reduces.

Also, when the coins are made of soft metal, they do not get damaged and wear in a short time.

Also, the coins are guided to the peripheral direction by the first pin and the second pin which are fixed.

As a result, the coins are dispensed every time.

In this present invention which is claimed in claim 4, in the invention of claim 3; further, includes

a fixed guide which is located near a line which connects between said first pin and said second pin, also it is located near said rotating disk, and

an outlet guide which continues to said guiding surface of said guiding hole and is located parallel to said line.

In this structure, a side of the coin is guided by the first pin, the second pin which are are dotted and the fixed guide and another side of the coin is guided by the outlet guide which is located parallel to them.

Accordingly, the coin is guided to the tangent direction of the rotating disk.

Therefore the coin which is moved by the rotating disk is guided smoothly to the dispensing slot.

As a result, irregular movement is prevented.

In this present invention which is claimed in claim 5, in the invention of claim 4;

the distance between said line and said outlet guide is from 21.5 mm to 21 mm, and the distance between a upper surface of said base and the reverse surface of said rotating disk is from 2.0 mm to 2.6 mm.

In this structure, when the coin is smaller than the dimensions, the smooth movement of one Yen coin is obstructed.

Therefore non-dispensing of the coin is sometimes unpreventable.

When the coin is larger than the dimensions, the coin moves in an abnormal direction.

Therefore non-detecting of the coin is sometimes unpreventable.

However when the above-mentioned dimensions are set up, the dispensing and the detecting becomes steady.

The steady effect was shown in an experiment.

### PREFERRED EMBODIMENTS OF THE INVENTION

FIG. 1 is an exploded perspective view of the coin hopper with the rotating disk of the embodiment.

FIG. 2 is a plan view of the coin hopper with the rotating disk of the embodiment (detached the coin bowl).

FIG. 3 is a section view of A-A line in FIG. 2.

FIGS. 4 to 7 are explaining views for operation of the embodiment.

Coin hopper 10 is explained referring to FIG. 1.

Sliding base 16 is made of stainless steel and is fitted into guiding hole 14 which is located at the upper surface of base 12 which is a plain plate and is circle.

The sliding base 16 can be made by resin which is abrasion-resistant and in integral molding method.

When they are separated, the resin can be changed to a cheaper resin.

Accordingly, sliding base 16 can be made up cheaper.

The periphery of guiding hole 14 is guiding surface 15 for coin C.

Rotating disk 20 is located in guiding hole 14 in level, and spacer 18 lies between the upper surface of sliding base 16 and the rotating disk 20.

Openings 22 are located at rotating disk 20 at a predetermined distance and are larger than coins C and pass through the perpendicular and are circle.

Openings 22 are tapered downwards, because coins can fall easily as shown in FIG. 3.

Therefore ribs 24 are located between openings 22.

Center section 26 of rotating disk 20 is semi-circle like in shape with ridgelines as it can agitate coins C.

Outputting shaft 30 of reducer 28 is located in base 12 and penetrates from the lower to the upper at the center section of sliding base 16.

The top of outputting shaft 30 is inserted into attaching hole 32 which is located in the center of rotating disk 20.

Rotating disk 20 is fixed at the top of outputting shaft 30 by screw 34.

Outputting shaft 30 is driven in the counter clockwise direction shown in FIG. 2 by electrical motor 36 which is fixed at the end of base 12 through reducer 28.

As shown in FIG. 3, the distance D1 between reverse surface 38 of rotating disk 20 and upper surface 40 of sliding base 16 is slightly larger than the thickness of coin C.

Pushing pieces 39 for coins C are located at the reverse of rib 24.

The distance D2 between lower ends and upper surface 40 of sliding base 16 is smaller than the thickness of coin C.

Pushing piece 39 includes pushing moving section 42 and pushing out section 44.

Pushing moving section 42 is an end surface which is located in front of the rotating direction of pushing moving rib 46 which is made in an arc at the rotating axis of rotating disk 20.

Also, pushing moving section 42 is a surface which has contact with fallen coin C which moves together with rotating disk 20 in tangent.

In other words, pushing moving section 42 is located adjacent to opening 22 and on the straight line LA which extends towards the periphery from the center of rotating disk 20 and has contact with the coin C at a position which is located near the cross point which crosses to arc Y and line LA.

Pushing moving section 42 is desirable to face contact to coin C, however they can have contact in line contact.

Pushing out section 44 is the outwards surface and is an end surface which is located in front of the rotating direction of pushing moving rib 46 which is made in an arc at the rotating axis of rotating disk 20.

Also, pushing out section 44 is located far from the pushing moving section 42 to the rotating axis, and is located behind the rotating direction rather than pushing moving section 42, and faces to the periphery of rotating disk 20.

In other words, pushing out section 44 is located on the line LB which crosses to the line in an obtuse angle.

First pin 50 and second pin 52 protrude on sliding base 16.

First pin 50 is located at the side of the rotating axis to pushing moving rib 46, and the top of pin 50 can be located at the first escaping groove 53 which is located at the reverse of rotating disk 20 and is an arc.

Second pin 52 can be located at second escaping groove 55 which is located between pushing out ribs 48 and 46.

As shown in FIG. 2, when the line which connects between the center of rotating disk 20 and the center of opening 22 crosses to the line LD which connects between the outer surface of first pin 50 and the outer surface of second pin 52, the inner edge of opening 22 is located near line LD.

Accordingly, coin C moves in the tangent direction to pins 50, 52.

Therefore the coin C is not pushed by a large force to pins 50, 52 by pushing moving section 42 and pushing out section 44.

The distance between first pin 50 and second pin 52 is set up where the coin C dees not move into the space between first pin 50 and second pin 52.

In other words, when coin C has contact with first pin 50 and second pin 52, the distance between the rim of coin C and the straight line LD is set up for 1 mm or less.

First pin 50 and second pin 52 are fixed at an end of blade spring 57 where another end is fixed at the reverse of sliding base 16.

Tops of pins 50 and 52 are semisphere.

Accordingly, when first pin 50 and second pin 52 are pushed over a predetermined force, they are moved into sliding base 16.

Dispensing slot 54 is located at the side of first pin 50 and second pin 52.

Dispensing unit 56 is located at dispensing slot 54.

Dispensing slot 56 includes fixed guide 58 and moving guide 60.

Fixing guide 58 is rotatable on the fixed shaft, and is located at the same side to pins 50, 52 to straight line LD and is located near rotating disk 20.

When coin C has contact with fixed guide 58 and second pin 52, the distance between fixed guide 58 and second pin 52 where the distance between the rim of coin C and straight line LD is set up for 1 mm or less.

Moving guide 60 includes lever 64 which is rotatable at fixed shaft 62 and roller 68 which is rotatable on shaft 66 which is fixed at the end of lever 64.

Lever 64 is urged in the counterclockwise direction by a spring (not shown) shown in FIG. 2, and is usually stopped by stopper 70 at the standby position as shown in FIG. 2.

In this standby position, the distance between fixed guide 58 and roller 68 is smaller than the diameter of coin C.

When moving guide 60 is pushed by coin C, it is pivoted in the clockwise direction in center at fixed shaft 58.

Therefore coin C can pass through between fixed guide 58 and moving guide 60.

The diameter section of coin C passes through between fixed guide 58 and moving guide 60 immediately after the coin C is dispensed from dispensing slot 54 by the reverse movement based on the spring (not shown).

The part like in rectangular shape which is located between moving guide 60 and guiding hole 14 is made of stainless steel and is guide 72 for coin C.

The guide includes arc guide 74 which is continued to guiding surface 15 of guiding hole 14 and outlet guide 76 which is located parallel to straight line LD.

Outlet guide 76 is either planar or linear.

The distance between line LD and guide 76; in other words, the distance between first pin 50 and outlet guide 76 is 21 mm which is larger than 20 mm which is the diameter of 1 Yen.

However the distance can be set up to 21.5 mm which was confirmed in an experiment.

Also, when the coin is 1 Yen, the distance between upper surface 40 of sliding base 16 and reverse 38 of rotating disk 20 is set up from 2 mm to 2.6 mm which is desirable.

In other words, when the distance is smaller than 2 mm, coin C receives large variations in the moving resistance based on the posture of the coin C.

As a result, the dispensing motion of coins C does not steady.

Also, when the distance is larger than 2.6 mm, the posture of coin C at the dispensing timing by fixed guide 58 and moving guide 60 changes drastically.

After-mentioned coin sensor 78 can not detect the coin C.

Coin sensor 78 is photo-electric type and is located at the end of dispensing slot 54, and detects the coin C and outputs a dispensing signal.

Storing bowl 80 is fixed at base 12 by fixing unit 82 in an easy operation and stores coins C in the bulk situation.

An outlet is circle and is located at the lower section of bowl 80.

Rotating disk 20 is located in the lower position.

However rotating disk 20 can be located at guiding hole 14 and can be located under bowl 80.

In other words, “at the bottom of bowl 80 ” includes the lower position of bowl 80 and the adjacent position which is under bowl 80.

The upper section of bowl 80 is rectangular and the upper surface is opened for entering coins C.

Next this embodiment which uses aluminum coin which is 1 Yen is explained referring to FIGS. 4 to 8.

Coins C are put into bowl 80, and the greater part of coins C are located on rotating disk 20 which is located at the bottom of bowl 80.

When rotating disk 20 rotates, coins C are agitated, fall into opening 22 and are supported on sliding base 16.

Coins C which are supported on sliding base 16 are pushed by pushing moving section 42.

Also the coins C are moved together with rotating disk 20 in the counterclockwise direction as shown in FIG. 4.

In this process, pushing moving section 42 pushes point D of contact to arc Y which is centered at the axis of rotating disk 20 and passes through the center of coin C which move along guiding surface 15 and arc guide 74.

In other words, coins C are pushed in a right angle to line LA which is through the center of rotating disk 20 at point D of contact by force F1.

The direction of force Fl is approximately tangent to arc Y.

Accordingly, a component of force F2 which adds to guiding surface 15 and arc guide 74 is small.

Guiding surface 15 and arc guide 74 are pushed by the resultant force which is the component of force F2 and centrifugal force F3 of coins C.

Rotating disk 20; in other words, the rotating speed of coins C is rather small.

Accordingly, coins C slide to guiding surface C and arc guide 74 in approximately a component of force F2.

Therefore the sliding resistance of coins C to guiding surface 15 and arc guide 74 is exceedingly small.

As a result, the resistance of rotating disk 20 is small; in other words motor 36 needs little electricity to work.

Also, when rotating disk 20 rotates, coin C is guided by outlet guide 76.

When coins C move and have contact with outlet guide 76 the coins do not have contact with first pin 50.

When coins C are located slightly away from outlet guide 76, the coins C have contact with first pin 50 (see dotted line in FIG. 5).

In this case, coins C are pushed to outlet guide 76 by a component of force F6 of resultant force F5 which composes pushing force F1 of pushing moving section 42 and reaction force F4 from first pin 50.

Therefore coins C are guided by outlet guide 76, and are moved towards dispensing slot 54 (FIG. 5).

Then, pushing force F1 of pushing moving section 42 and reaction force F4 of first pin 50 make an obtuse angle, however the obtuse angle is rather small.

Therefore the nipping force to coin C is small.

As a result, the coin C is not deformed.

Afterwards, the coin C is guided in a predetermined posture by outlet guide 76, first pin 50, the upper surface 40 of sliding base 16 and reverse 38 of rotating disk 20.

In other words, the posture of coin C is limited by the space which is enclosed in the above- mentioned parts.

As a result, coin C is guided in parallel to upper surface 40.

Also, when rotating disk 20 rotates, coin C has contact with roller 68, and is pushed to the side of second pin 52, and is pushed towards dispensing slot 54 by pushing out section 44.

When coin C is held by fixed guide 58 and roller 68, lever 64 is pivoted in the clockwise direction (shown in FIG. 6).

When rotating disk 20 further rotates, coin C is pushed by pushing out section 44 which is outwards.

Also coin C is pushed out to dispensing section 54 by second pin 52 together with pushing out section 44.

Then, the direction of pushing force F7 based on pushing out section 44 is parallel to outlet guide 76.

Also, the angle which is made by force F7 and reaction force F8 of second pin 52 is an obtuse angle, however the angle is rather small.

Therefore coin C does not receive large holding force.

Also, coin C receives pushing force F9 from moving guide 60, however the pushing force is small.

As a result, the aluminum coin C is not deformed.

Also, the coin C is guided in a predetermined posture by outlet guide 76, first pin 50, the upper surface 40 of sliding base 16 and reverse 38 of rotating disk 20.

In this posture, the coin C is held by moving guide 60 and second pin 52.

Therefore the posture of coin C is kept; in other words, the coin C is kept parallel to sliding base 16.

Afterwards, coin C which is held by fixed guide 58 and moving guide 60 is pushed towards dispensing slot 54 by pushing force F7 based on pushing out section 44.

Also, moving roller 68 is further pivoted in the clockwise direction by the coin C (shown in FIG. 7).

Then, the coin C is pushed by the outer slanting surface of pushing out section 44.

Therefore the holding force to coin C by fixed guide 58, moving guide 60 and pushing out section 44 is small.

As a result, the coin C does not get damaged.

Also, coin C continues in the situation which is approximately parallel to sliding base 16.

The diameter section of coin C passes through fixed guide 58 and moving guide 60, immediately after, the coin C is flipped from dispensing slot 54 by moving guide 60 based on the movement in the counterclockwise direction.

### Effect of the Invention

In this present invention which is claimed in claim 1, the coin is pushed to the straight line in a right angle, because the pushing moving section is located approximately on the straight line which extends towards the periphery direction from the center of the rotating disk.

Therefore the friction resistance between the coin and the guiding surface is small.

As a result, the rotating resistance of the rotating disk is small.

As a result, the consumption energy of the electrical motor reduces.

Also, when the coins are made up from soft metal, they do not get damaged and wear in a short time.

In this present invention which is claimed in claim 2, the rotating disk includes an opening which passes through said coins and said pushing moving section and pushing out section is located below and adjacent said opening.

As a result, the storing amount of coins is increased, however the coin hopper is small.

In this present invention which is claimed in claim 3, the coin is pushed to the guiding surface in a resultant force which is based on a component of a force of the moving out section and the centrifugal force.

The centrifugal force is drastically small and the pushing force of the pushing moving section adds to the tangent direction to a circle which is the center of the rotating disk and is on a point of contact between the guided coin and the pushing moving section.

Therefore the component of the force which pushes to the guiding surface is small.

Accordingly, the friction resistance between the coin and the guiding surface is small.

As a result, the consumption energy of the electrical motor reduces.

Also, when the coins are made up from soft metal, they does not damaged and wear in a short time.

Also, the coins are guided to the peripheral direction by the first pin and the second pin which are fixed.

As a result, the coins are dispensed every time.

In this present invention which is claimed in claim 4, further, includes a fixed guide which is located near a.straight line which connects between said first pin and said second pin, also it is located near said rotating disk, and an outlet guide which continues to said guiding surface of said guiding hole and is located parallel to said line.

In this structure, a side of the coin is guided by the first pin, the second pin which are are dotted and the fixed guide and another side of the coin is guided by the outlet guide which is located parallel to them.

Accordingly, the coin is guided to the tangent direction of the rotating disk.

Therefore the coin which is moved by the rotating disk is guided smoothly to the dispensing slot.

As a result, the irregular movement is prevented.

In this present invention which is claimed in claim 5, the distance between said straight line and said outlet guide is from 21.5 mm to 21 mm, and the distance between a upper surface of said base and the reverse surface of said rotating disk is from 2.0 mm to 2.6 mm.

In this structure, both the dispensing and the detecting of coins becomes constant. The steady effect was shown in an experimentation.

### BRIEF DESCRIPTION OF THE DRAWINGS

FIG. 1 is an exploded perspective view of the coin hopper with the rotating disk of the embodiment.

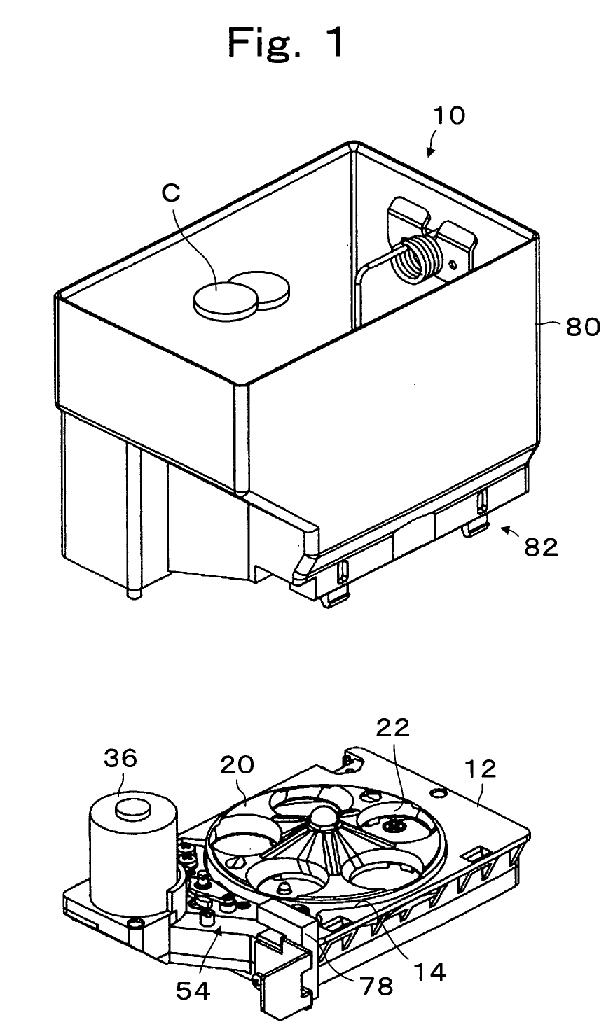

FIG. 2 is a plan view of the coin hopper with the rotating disk of the embodiment (detached the coin bowl).

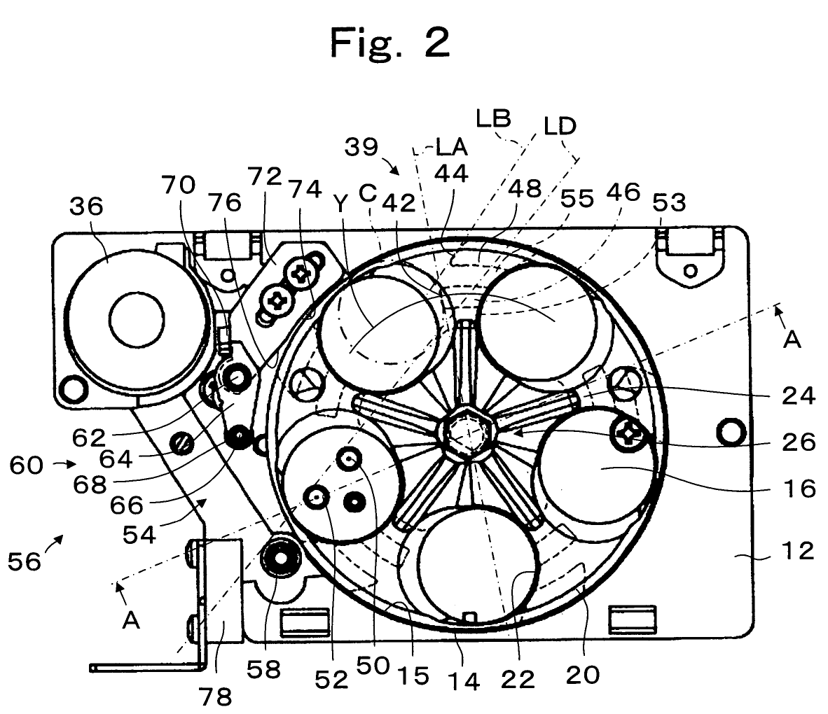

FIG. 3 is a section view of A-A line in FIG. 2.

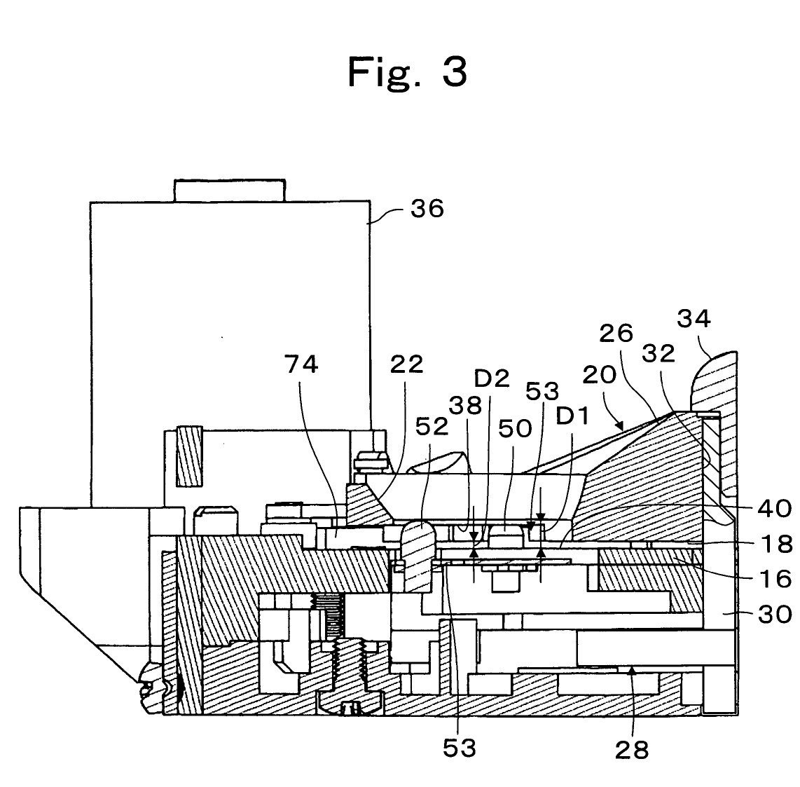

FIG. 4 is an explaining views for operation of the embodiment.

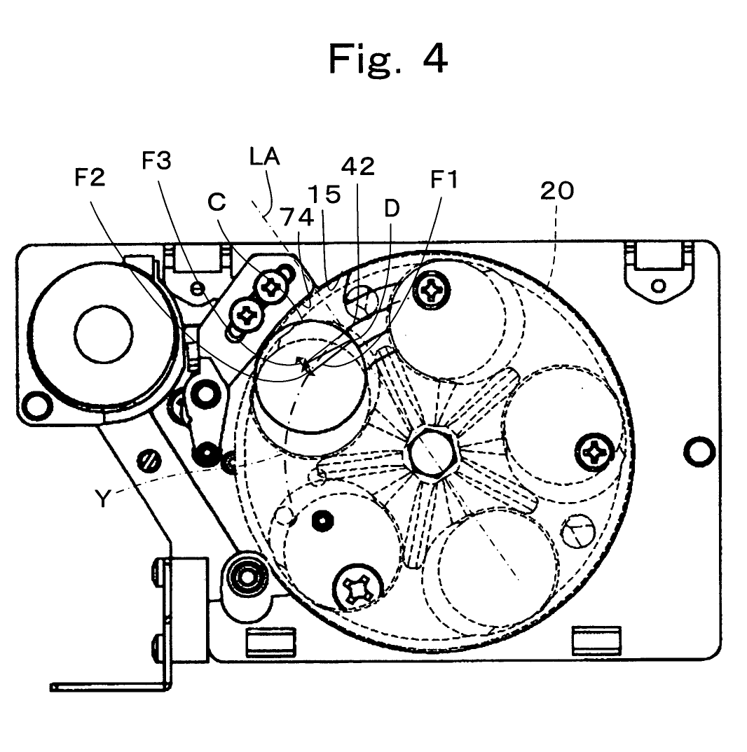

FIG. 5 is an explaining views for operation of the embodiment.

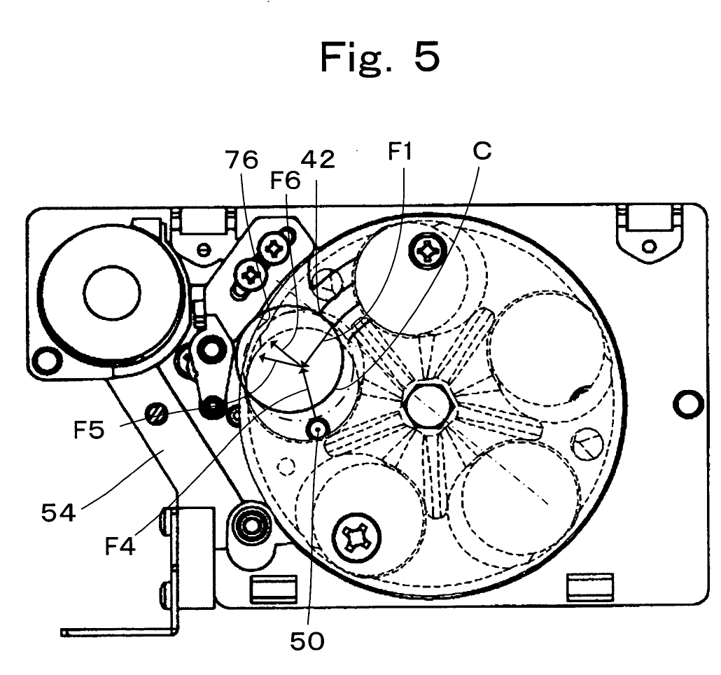

FIG. 6 is an explaining views for operation of the embodiment.

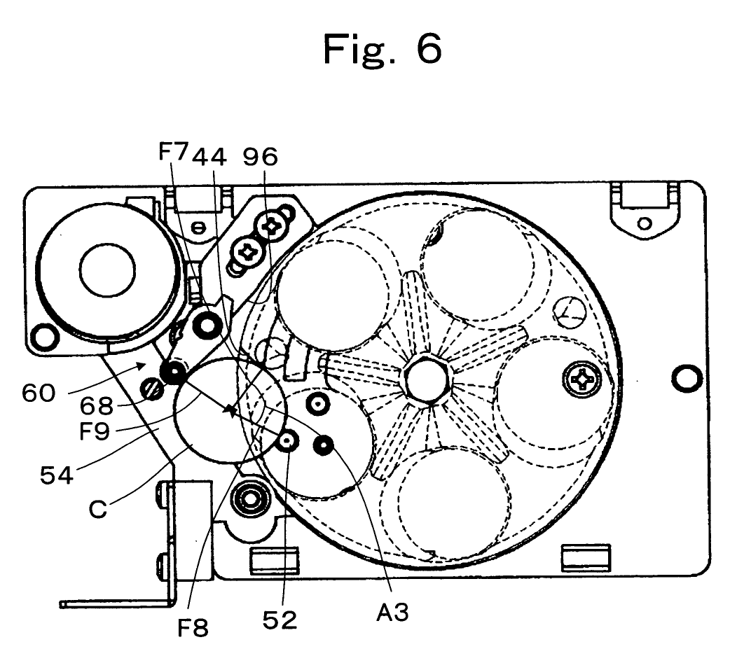

FIG. 7 is an explaining views for operation of the embodiment.

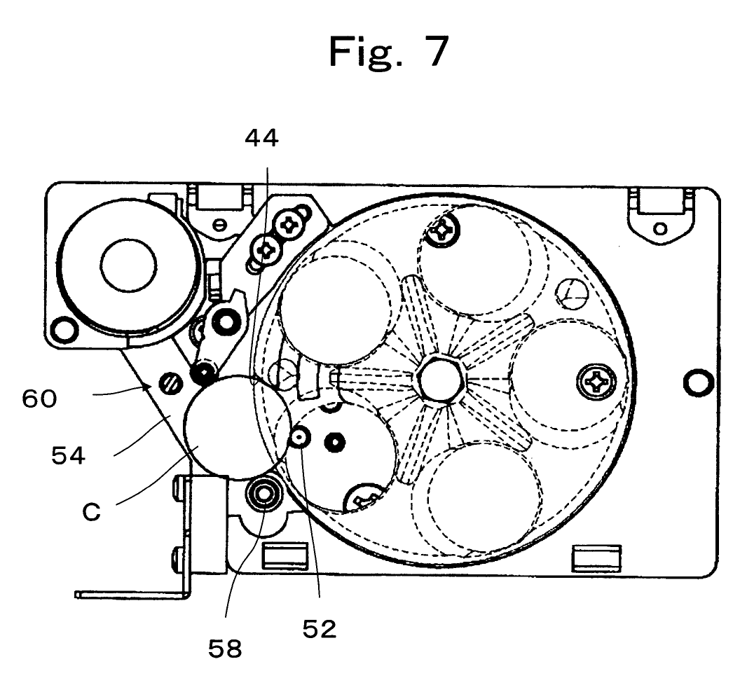

### DESCRIPTION OF THE CODE

14 guiding hole
16 sliding base
20 rotating disk
22 opening
38 reverse
39 pushing piece
42 pushing moving section
44 pushing out section
50 first pin
52 second pin
58 fixed guide
76 outlet guide
80 storing bowl
C coin
LA a straight line which extends towards the periphery from the rotating center
LB a straight line make in an obtrude
LD a straight line

1 A coin hopper comprises of;
a bowl (80) which stores coins (C),
a rotating disk (20) which is located at the bottom section of said bowl and has a pushing piece (39) for pushing said coins (C), and
a guiding surface (15) which guides said coins (C) which move together with said rotating disk (20),
characterized in that,
said pushing piece (39) has a pushing moving section (42) and a pushing out section (44),
said pushing moving section which is located on an extending straight line (la) which extends towards the circumferential direction,
said pushing out section which is located at the outer side of said pushing moving section and is located on a straight line (lb) which crosses in an obtuse angle to said line (la):

2 The coin hopper claimed in claim 1;
said rotating disk (20) includes an opening (22) which passes through said coins (C) and said pushing moving section (42) and pushing out section (44) which is located below and adjacent said opening (22).

3. A coin hopper comprises of;
a bowl (80) which stores coins (C),
a rotating disk (20) which is located at the bottom section of said bowl and has a pushing piece (39) for pushing said coins (C),
a guiding hole (14) which includes a guiding surface (15) which guides said coins (C) and where said rotating disk (20) is located into said guiding hole,
a base (16) which is located at the bottom of guiding hole (14) and can slide said coins (C) which pass through said opening (22),
a first pin (50) and a second pin (52) which protrude from said base (16), characterized in that,
said pushing piece (39) includes a pushing moving section (42) and a pushing out section (44),
said pushing moving section which is located on an extending straight Iine (LA) which extends towards the circumferential direction,
said pushing out section which is located at the outer side of said pushing moving section and is located on a straight line (LB) which crosses in an obtuse angle to said line (LA),
said pushing moving section is located between said first pin (50) and said second pin (52),
said pushing out section (44) is located outside of said second pin (52).

4. The coin hopper claimed in claim 3; further, includes
a fixing. guide (58) which is located near a straight line (LD) which connects between said first pin (50) and said second pin (52), also it is located near said rotating disk (20), and
an outlet guide (76) which continues to said guiding surface (15) of said guiding hole (14) and is located parallel to said line (LD).

5. The coin hopper claimed in claim 4,
the distance between said straight line (LD) and said outlet guide (76) is from 21.5 mm to 21 mm, and the distance (Dl) between an upper surface (40) of said base (16) and the reverse surface (38) of said rotating disk (20) is from 2.0 mm to 2.6 mm.
